(19) United States
(12) Patent Application Publication
(10) Pub. No.: US 2016/0259851 A1
(43) Pub. Date: Sep. 8, 2016

(54) SYSTEM AND METHODS FOR GENERATING TREEBANKS FOR NATURAL LANGUAGE PROCESSING BY MODIFYING PARSER OPERATION THROUGH INTRODUCTION OF CONSTRAINTS ON PARSE TREE STRUCTURE

(71) Applicant: THE ALLEN INSTITUTE FOR ARTIFICIAL INTELLIGENCE, SEATTLE, WA (US)

(72) Inventors: Mark Andrew Hopkins, Bellevue, WA (US); Mark Edwin Schaake, Seattle, WA (US); Samuel Stuart Skjonsberg, Seattle, WA (US)

(21) Appl. No.: 15/059,722

(22) Filed: Mar. 3, 2016

Related U.S. Application Data
(60) Provisional application No. 62/128,275, filed on Mar. 4, 2015.

(51) Int. Cl. G06F 17/30; G06F 17/27

(52) U.S. Cl. CPC G06F 17/30719; G06F 17/30716; G06F 17/2725

(57) ABSTRACT

Systems, apparatuses, and methods for generating a parser training set and ultimately a correct treebank for a corpus of text, based on using an existing parser that was trained on a different corpus. Also disclosed are systems, apparatuses, and methods for improving the operation of a parser in the case of using a less familiar set of training data than is typically used to train conventional parsers. This can be used to generate a more effective and accurate parser for a new corpus (and hence more accurate parse trees) with significantly less effort than would be required if it was necessary to generate a standard size training set.

### CROSS REFERENCE TO RELATED APPLICATION

This application claims the benefit of U.S. Provisional Application No. 62/128,275, entitled “System and Methods for Generating Treebanks for Natural Language Processing by Modifying Parser Operation through Introduction of Constraints on Parse Tree Structure,” filed Mar. 4, 2015, which is incorporated by reference herein in its entirety (including the Appendix) for all purposes.

### BACKGROUND

Natural language processing (NLP) is a field of computer science, artificial intelligence, and linguistics concerned with the interactions between computers and human (natural) languages. As such, NLP is related to the area of human—computer interaction and the understanding and interpretation of words, sentences, and grammars. Some of the challenges in NLP involve natural language understanding, that is, enabling computers to derive meaning from human or natural language input, and others involve natural language generation, such as for interactive voice response (IVR) systems.

One aspect of understanding and/or interpreting language involves the construction of a model or representation of a string of words, such as a sentence. The model or representation may be based on an underlying set of rules or relationships that define how communication is conducted using a language, such as a specific grammar. The model or representation may be constructed using a process or operation termed “parsing” or as the output of the operation of an element known as a parser. A natural language parser is a software program that may be used to analyze the grammatical structure of sentences, for instance, which groups of words go together (as “phrases”) and which words are the subject or object of a verb. Probabilistic parsers use knowledge of language gained from hand-parsed (and presumably correct) sentences to try to produce the most likely analysis of new sentences. This typically involves the development of a training set of sentences that have been correctly parsed and then used as examples of correct outputs for the parser to learn from.

Parsing or syntactic analysis is the process of analyzing a string of symbols, either in natural language or in a computer language, conforming to the rules of a formal grammar. The term has slightly different meanings in different branches of linguistics and computer science. Traditional sentence parsing is often performed as a method of understanding the meaning of a sentence, sometimes with the aid of devices such as sentence diagrams. It typically emphasizes the importance of grammatical elements such as subject and predicate. Within computational linguistics the term is used to refer to the formal analysis by a computer of a sentence or string of words into its constituents, and may produce a parse tree or other structure showing their syntactic relation to each other, which may also contain semantic and other information. As a result, the efficient and accurate generation of a parse tree or other representational structure is an area of research, as it is a tool used in other aspects of NLP work.

A “treebank” is a parsed text corpus that annotates syntactic or semantic sentence structures. Treebanks are often created on top of a corpus that has already been annotated with part-of-speech tags. In turn, treebanks are sometimes enhanced with semantic or other linguistic information. Treebanks can be created completely manually, where linguists annotate each sentence with syntactic structure, or semi-automatically, where a parser assigns some syntactic structure which linguists then check and, if necessary, correct. In practice, fully checking and completing the parsing of natural language corpora is a labor-intensive project that can take teams of graduate linguists several years. The level of annotation detail and the breadth of the linguistic sample determine the difficulty of the task and the length of time required to build an acceptable treebank. Treebanks can be used as training data for a parser and as a source of research data in their own right for purposes of linguistic analysis, etc.

Typically, a parser is a computer implemented process or set of operations that takes a string of words as an input and uses a selected grammar (which is represented by the specific operations, rules, etc. that are implemented by the process) to determine the relationships between the words and represent the string as a tree or other structure. The parser may function to select a specific operation on (or manipulation of) one or more of the words in the process of determining the relationship(s) that satisfy the definitions and requirements of the grammar. The selected operation or manipulation may be the result of applying a set of rules or conditions that satisfy or define the grammar, and represent allowable, required, or impermissible relationships between words or sequences of words or elements.

Parsers are typically “trained” using a set of input data that represent what are considered to be “correctly” parsed sentences or strings, such as the previously mentioned “treebank”. However, there are a limited number of sets of such correctly parsed sentences/strings, as it requires a substantial amount of work to create them. This has the unfortunate side effect that many parsers are optimized to produce correct outputs based on a set of inputs that is representative of a particular type or category of sentences or strings (and which may satisfy a specific grammar), but may not include sufficient examples of strings or relationships that occur in other areas (such as other forms of logical relationships, statements, questions, dependent phrases, grammars, etc.). The result is to produce a parser that is generally accurate for inputs that are sufficiently close to or related to the training set, but that may introduce errors for other types of input sentences, strings, grammars, or structures. Since a parser is used to generate the output data that serves as the basis for constructing a parse tree (and hence a treebank), this means that the parse trees created using parsers trained in such a manner will also have errors.

Conventional approaches to generating a parse tree or treebank typically rely on using a parser that was trained on one of a limited number of sets of training data. While useful, this approach is inherently limited as the parser becomes optimized for sentences or data strings that are closer to, or share certain characteristics with, the training set. This can result in errors in the parse trees constructed for the actual inputs, if those inputs differ in certain ways from the training set. As a result, a treebank built from a specific corpus may also contain errors, or at least be sub-optimal in terms of its accuracy and utility. Thus, systems and methods are needed for more efficiently and correctly generating training data, parse trees, and a treebank from a corpus of text that differs from the data used to train an existing parser. Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for generating a parser training set and ultimately a correct treebank for a corpus of text, based on using an existing parser that was trained on a different corpus, and in some cases, a corpus of a different type or character (e.g., using a parser initially trained on speeches to parse a corpus comprised of hypothetical questions). In some embodiments this is achieved by modifying the operation of the previously trained parser through the introduction of one or more constraints on the output parse tree it creates, and then performing one or more re-iterations of the parsing operation. This causes the parser to be re-trained on samples of the new corpus in a more efficient manner than by use of conventional approaches (which are typically very labor intensive).

Embodiments of the invention are also directed to systems, apparatuses, and methods for improving the operation of a parser in the situation of using a less familiar set of training data than is typically used to train a conventional parser. These implementations of the invention can be used to generate a more effective and accurate parser for a new corpus of inputs (and hence produce more accurate parse trees) with significantly less effort than would be required if it was necessary to generate a standard size training set.

In one embodiment, the invention enables the input of an instruction, signal, or command that operates to cause the parser to prevent the formation of a specified connection between inputs. In one embodiment, the invention enables the input of an instruction, signal, or command that operates to cause the parser to require a certain connection between inputs. As a result of the instruction, signal, or command, when the parser “re-parses” the input it generates a more accurate representation of an input sentence with less reliance on a typical sized training set. In some embodiments the invention may be used to generate a treebank based on a new corpus of text in a more efficient manner than by use of conventional approaches to constructing a treebank.

In one embodiment, the invention is directed to a method for modifying the operation of a parser, where the method includes:

receiving data representing an input sentence;

generating a display of a structure representing the input sentence based on a specific parsing process;

receiving one or more inputs representing changes to the displayed structure;

generating a corrected structure representing the input sentence based on the specific parsing process as modified by the received inputs; and

training a parser to reliably learn a parsing process based on the specific parsing process as modified by the one or more received inputs.

In another embodiment, the invention is directed to an apparatus for An apparatus, comprising:

an electronic data processing element;

a set of instructions stored on a non-transient medium and executable by the electronic data processing element, which when executed cause the apparatus to
receive data representing an input sentence;
generate a display of a structure representing the input sentence based on a specific parsing process;
receive one or more inputs representing changes to the displayed structure;
generate a corrected structure representing the input sentence based on the specific parsing process as modified by the received inputs; and
train a parser to reliably learn a parsing process based on the specific parsing process as modified by the one or more received inputs.

In yet another embodiment, the invention is directed to a system comprising:

a data storage element containing data representing one or more sentences or strings of characters;

an electronic data processing element;

a set of instructions stored on a non-transient medium and executable by the electronic data processing element, which when executed cause the system to
generate a visual display of a structure representing the result of parsing one of the sentences or strings of characters using a first parsing process;
receive one or more inputs representing changes to the displayed structure;
generate a visual display of a corrected structure, the corrected structure representing the result of parsing the sentence using the first parsing process as modified by the received inputs; and
train a parser execute a second parsing process, the second parsing process being based on the first parsing process as modified by the one or more received inputs.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating the parsing of a sentence that may occur as part of a communication process, and how a person may visualize that parsing;

FIG. 2 is a diagram illustrating a communication process between two people and certain of the parsing and interpretation operations/processes that may occur;

FIG. 3 is a flowchart or flow control diagram illustrating certain functional or operational elements that may be implemented as part of a parsing and/or interpretive process, and that in some cases may be implemented in part by an embodiment of the invention;

FIG. 4 is a diagram illustrating a hierarchical relationship (a parse tree) between elements of a parsed sentence or string of elements;

FIG. 5 is a diagram illustrating certain functional or operational elements or processes that may be implemented as part of an embodiment of the invention;

FIGS. 6(a) through 6(c) are diagrams illustrating how an input from an annotator or a decision process may be used to alter the operation of a previously trained parser when that parser is applied to an input from a different domain;

FIGS. 7(a) through 7(c) are diagrams illustrating how new constraints are used to train a parser on an input from a new domain by incorporating the constraints into the construction and traversal of a search tree;

FIG. 8 is a diagram illustrating an adaptive process, method, or operation for modifying the operation of a parser and that may be used when implementing an embodiment of the invention; and

FIG. 9 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the present invention are directed to systems, apparatuses, and methods for more efficiently generating a set of parse trees or a treebank from a corpus of text, by modifying the operation of a parser that has previously been trained on a different corpus. In some embodiments, a human annotator may provide a correction or instruction that is used by the parser to modify/correct a parsing operation when it re-parses a previously input and parsed string of characters or elements. The correction or instruction may be in the form of a requirement that the output parse tree(s) contain a specific connection (or arc) between input elements (such as words) or that the output parse tree(s) not contain a certain connection between input elements (i.e., such a connection or relationship is forbidden). Other forms of correction, modification, conditions, or instruction are also possible (such as those mentioned later herein). The information provided by the annotator assists in training the parser more quickly on the new corpus of text, and hence in producing a correct set of parse tress and treebank based on the new corpus.

In some embodiments, the correction, modification, or instruction may be provided to the parser in the form of a control signal that is generated by a process that applies one or more rules or evaluations (such as by a cost or value function, or by a machine learning technique) to the parser output. The control signal may be part of an adaptive feedback process that causes the parser to converge towards correct operation on inputs representing the new corpus. In such embodiments, the parser operation may be modified by a process that may rely less on human inputs, if at all.

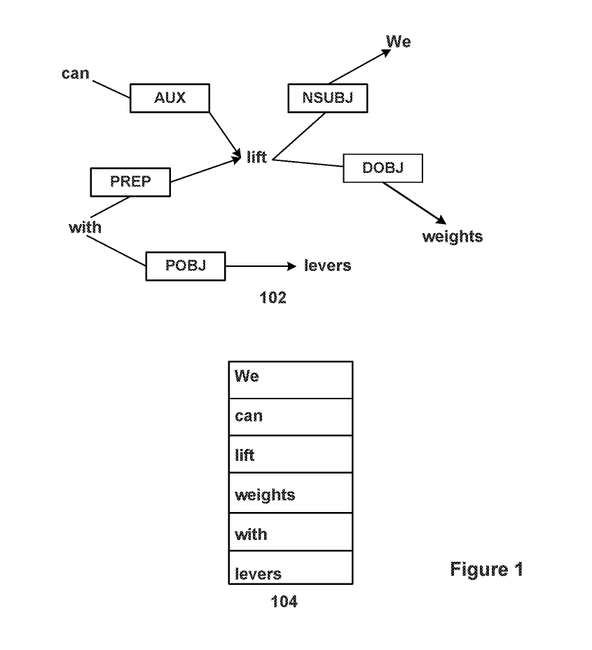

FIG. 1 is a diagram illustrating the parsing of a sentence 102 that may occur as part of a communication process, and how the sentence must be “flattened” or ordered in order to communicate the content of the sentence to someone else. This “flattening” or “ordering” may remove certain information about the relationships between elements of the sentence from the representation; as a result, knowledge about the grammar used to construct the sentence is needed in order to properly reconstruct and interpret it. As shown in the figure, if a person wishes to understand the meaning conveyed by the sentence “We can lift weights with levers”, they will perform one or more operations in their mind 102 to arrange and interpret the elements of the sentence (i.e., the individual words) in accordance with a learned grammar. This will involve identifying the role or function of certain words within the sentence (typically based on the grammar), and from that determining a meaning or reasonable interpretation of the sentence. Typically, the sentence will be represented conceptually in a linear form 104, as a set of words arranged in a “linearization” suitable for communication.

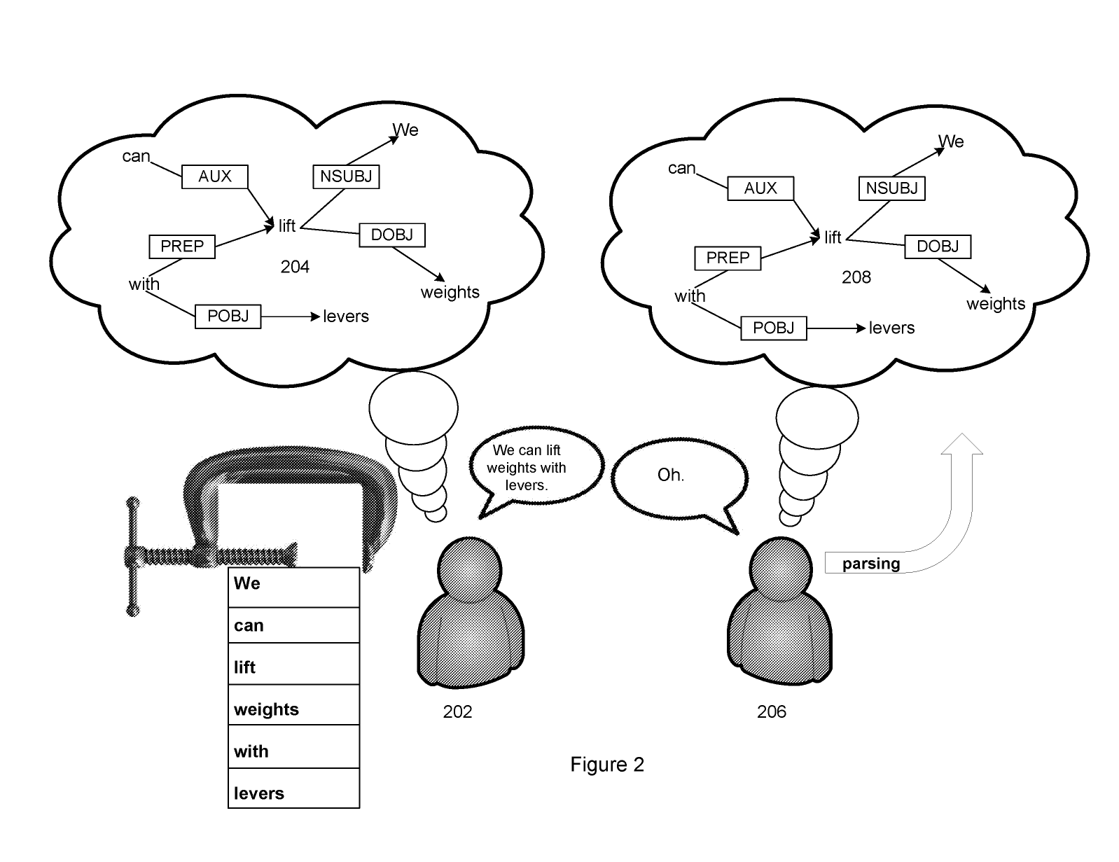

As shown in the FIG. 102, the word lift takes two arguments: a subject (we) and an object (weights). It is modified by an auxiliary verb (can) and a prepositional modifier (with levers). However, when we want to communicate this meaning, we cannot vocalize the tree structure, so we need to “flatten” or “linearize” it to a form such as shown by element 104. The person who hears this sentence then needs to reconstruct the original hierarchical structure by applying their own understanding of the grammar in order to identify the subject or subjects of the sentence, the verbs, the relationships implied by certain terms, etc. This communication process involves a form of parsing and is illustrated in FIG. 2. When we make the additional assumption that the meaning representation is in the form of a “tree” of words, then this process is referred to as “dependency parsing”.

As mentioned, FIG. 2 is a diagram illustrating a communication process between two people and certain of the parsing and interpretation operations/processes that may occur (either explicitly or implicitly as part of understanding a communication based on a common language and grammar). As shown in the figure, a first person 202 may visualize a representation (i.e., a parsing) of a sentence or thought as an arrangement of words that are linked together by grammar based relationships 204. This arrangement 204 is part of the process of the speaker 202 visualizing and then conveying a desired meaning as part of the communication. When the person 202 speaks the sentence, the listener 206 hears the words and then performs a similar type of parsing operation internally 208 in order to attempt to fully understand what is meant by the speaker. Typically, if both parties are using the same grammar and have a sufficient understanding of it, then the parsing each conducts internally (i.e., the representations 204 and 208) will be substantially the same. Note that if the parsing of the two parties is different, then this means that the intended concept has been miscommunicated. This often happens when the listening party is a computer, resulting in undesired behavior from the computer. In some embodiments, the invention is intended to help reduce the frequency of this miscommunication, particularly in novel domains.

A natural language parser is a software/computer implemented process or component that takes natural language text as an input and produces a hierarchical data structure as an output. Typically, this data structure represents syntactic or semantic information that is conveyed implicitly by the input text (based on its arrangement and the assumed underlying grammar). The parsing operation may be preceded by a separate lexical analyzer (sometimes referred to as a “tokenizer”), which creates “tokens” from the sequence of input characters.

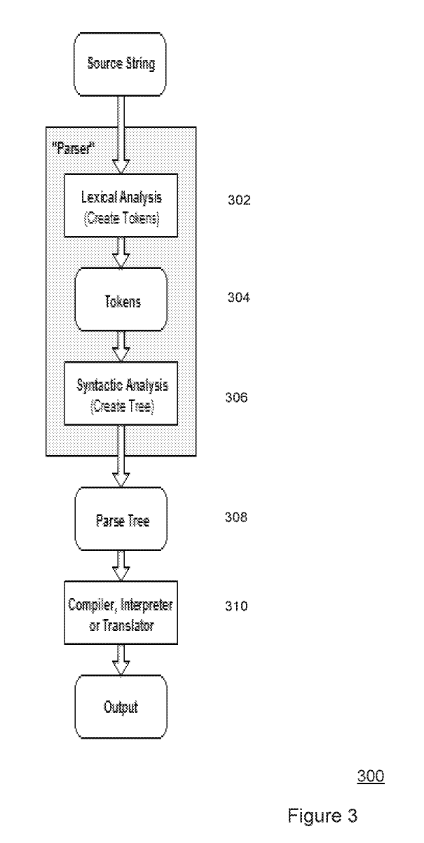

FIG. 3 is a flowchart or flow control diagram illustrating certain functional or operational elements that may be implemented as part of a parsing and/or interpretive process 300, and that in some cases may be implemented in part by an embodiment of the invention. For some uses, the figure illustrates the primary functions, operations, methods, or processes that are implemented by a typical parser. The following example demonstrates a common case of parsing language with two levels (types or classes) of grammar, lexical and syntactic:
The first stage is the token generation, or lexical analysis 302, by which the input character stream is split into meaningful chunks as defined by a grammar of regular expressions (e.g., these chunks may represent building blocks of more complicated concepts, a fundamental unit of information or meaning, etc). For example, the sequence/stream “he didn't go.” might be split into the token sequence [“he”, “did”, “n't”, “go”, “.”]. The output of this phase is typically a set of one or more tokens 304;
The next stage is syntactic analysis 306, which (re)constructs a hierarchical structure assumed to be implicit in the flattened sentence/sequence representation. In natural language parsing, this hierarchical structure can take a variety of forms, including (but not limited to):
   a dependency tree, which is a tree whose nodes correspond one-to-one with the tokens of the input sentence; or
   a constituent tree, which is a rooted tree whose leaves correspond one-to-one with the tokens of the input sentence.
      These graphical structures 308 (termed a “parse tree” in the figure) are typically further annotated with additional arc and node labels that supply additional information about the sentence, such as part-of-speech tags or constituent tags.

The final phase of the illustrated process is semantic parsing or analysis 310, which involves determining the implications of the expression that was reconstructed/validated, and taking the appropriate action. In the case of a calculator or interpreter, the action is typically to evaluate the expression or program; a compiler, on the other hand, would be expected to generate some kind of instruction set or code. Note that attribute grammars can also be used to define these actions.

In some sense, the operation of a generic parser may be described (at a high level) as implementing a sequence of data processing steps, functions or operations. These may include one or more of:
Receiving an input sequence/string (e.g., text, alphanumeric characters, words, etc.);
Identifying one or more of the elements of the input string that constitute a “unit” for purposes of further processing (such as an individual word, letter combination, number, operation, process-able string segment, etc.);
Accessing a set of rules, constraints, permissible operations, or impermissible operations, and/or a function that permits evaluating the “cost” or “value” of a specific arrangement of one or more “units” (such as a function representing a value for a connection between two units or nodes of a tree structure, and a rule that seeks to maximize that value subject to a condition or constraint);
   For example, this might take the form of a set of transition operators that control (e.g., create, permit, or prevent) the construction of connections between nodes or states of a network structure based on the underlying grammar, applicable rules or constraints, etc.;
Based on the outcome of evaluating the set of rules/constraints/function (such as by applying the set of operators), placing a “unit” in its appropriate relationship to another unit or units in the output (where this may be defined by a position in a sequence, a node in a network being constructed, a location relative to other previously placed units, etc.);
Introducing a new “unit” and applying any applicable rules, operations, conditions, or constraints to determine its set of possible placement(s) in relation to previously placed “units”;
Evaluating the cost or value function (e.g., as needed and by executing a search) for:
   all previously placed units/nodes and the connections between those units/nodes;
   each placement of the new unit/node from the set of possible placements, and considering the possible connections to the new unit/node from one or more of the previously placed units/nodes;
Determining a final network/node/connection arrangement that satisfies a desired cost/value condition (such as maximum, minimum, having a certain characteristic, not exceeding a specified threshold value, etc.); and
Repeating certain of the above steps until each “unit” has been placed into the output, sequence, string, or network structure.

Note that the description of the operation of a generic parser relies on a set of rules, constraints, functions, etc. that may not be optimal or even suitable for certain grammars and/or domains. The parser's “learning” of the grammar and ability to construct an accurate network representation of a new string/sentence after being trained on a set of correctly parsed strings/sentences means that the trained parser operates in accordance with (i.e., makes decisions based on) the rules/patterns of the specific grammar and/or acceptable practices of a certain domain. However, those rules, patterns and/or practices may not be optimal, relevant, or applicable for a different domain (such as text that represents a different category of information or has a different sentence structure). This is one reason why a parser that is trained on a specific domain may not produce sufficiently accurate results when used to evaluate a string/sentence from another domain.

To resolve this problem, when attempting to construct a set of treebanks or network diagrams for a specific domain, in one embodiment, the invention permits the introduction of a new rule or constraint based on an input provided by a person or one generated by an automated learning process. The new rule or constraint causes a change in the operation of the process that evaluates the “value” of a specific arrangement of “units”/nodes and connections. This typically alters the final structure of the network or “tree” that is determined to maximize/minimize/optimize the cost or value function for that arrangement of “units”/nodes. As will be described in greater detail, in some embodiments, the constraint may prevent a certain connection, require a certain connection, set a certain fixed or variable value for a certain connection, place a minimum or maximum threshold value on a certain connection, or apply other suitable constraint, rule, requirement or condition.

This approach permits the parser to adaptively and efficiently alter/modify its operation to take into account the new rule or constraint, and as a result, to generate a new parse tree or other representative structure (such as a network diagram, etc.) for a string/sentence from a different domain. Embodiments of the inventive system and methods utilize a user/person/annotator (and/or a machine learning process that functions in a similar manner) to more efficiently (as compared to building a new parser) train the parser on the new domain.

This is of great value when applying a previously trained parser to a new type of input, such as that from a different category or type of input than was used to initially train the parser (such as a type of input having a different grammar or set of controlling rules than the training set). As a result, a treebank or other form of output may be generated more quickly than by use of conventional approaches to building and training natural language parsers.

In natural language parsing, one task of a parser is to recover the most probable latent hierarchical structure from a flat representation of a sentence or string of characters (i.e., to construct a parse tree or other representation of nodes and connections from the flat structure). There are at least two ways in which this is conventionally done:
Stochastic grammar-driven: In this approach, the sentence is assumed to be generated from a weighted context-free grammar (i.e., a context-free grammar whose rules are associated with real-valued costs). Standard parsing algorithms (e.g., CKY, Earley, etc.) can be used to compute the lowest-cost tree that yields the input sentence, according to the weighted grammar; or
Operator-driven: In this approach, the tree is assumed to be generated by the application of a fixed-length sequence of operators. The cost of applying an operator is a function of the input sentence and the operators applied so far. Typically the lowest-cost tree is approximated using “greedy” or “beam” search.

Current state-of-the-art dependency parsers are statistical in nature. That is, they learn how to parse from examples. Specifically, given a treebank (i.e., a database of sentences and their correct parsing), these systems train statistical models that are then used to parse new sentences, and often with a relatively high degree of accuracy. However, one of the disadvantages of current statistical parsers is their reliance on the Penn Treebank, a database of roughly 40,000 hand-parsed sentences from the Wall Street Journal. Since most freely available parsers train nearly exclusively on this treebank, they tend to be good at parsing news articles (as would be expected, given the source), but poorer at operating in other domains in which different grammars or terminology may apply.

Although there have been smaller-scale efforts to build more hand-parsed treebanks to be used for training a parser, the total number of publicly available hand-parsed trees is a relatively small number (e.g., they number in only the tens of thousands). Unfortunately, people have not developed more varied and larger treebanks because constructing parse trees can be difficult and time-consuming. As noted, embodiments of the inventive system and methods described herein are intended to address this problem by, among other things, providing a way to adaptively modify a parser trained on one set of correctly parsed inputs so that it may operate more effectively and accurately on a set of inputs from a different domain and/or that follow a different grammar.

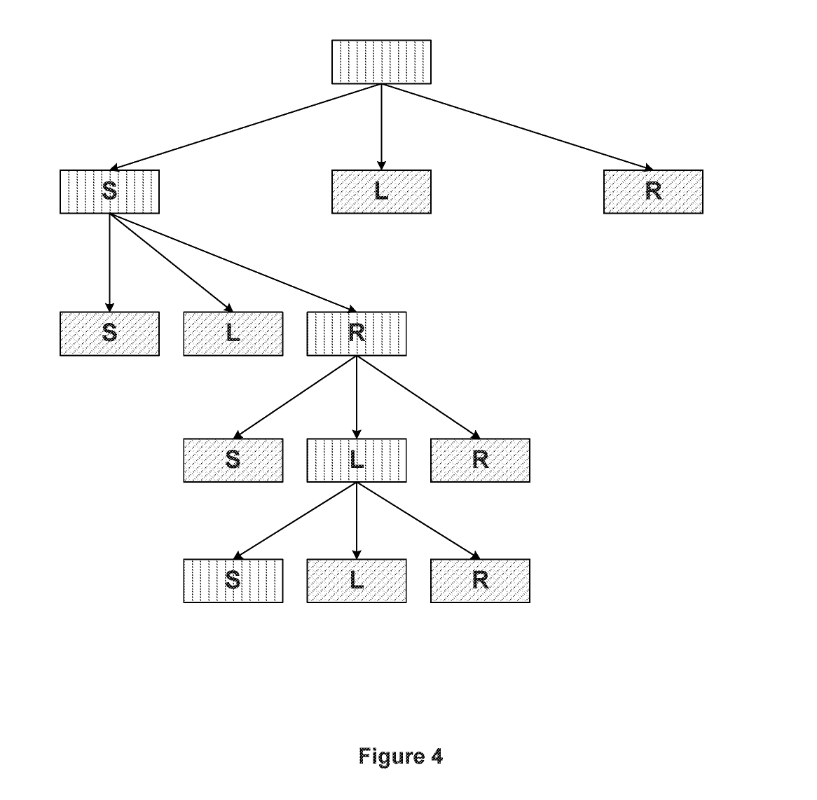

FIG. 4 is a diagram illustrating a hierarchical relationship (a parse tree) between elements of a parsed sentence or string of elements. This structure represents the output of a parser that operates based on a framework termed “transition-based dependency parsing”, which was developed by Swedish researcher Joakim Nivre and his colleagues. Transition-based dependency parsing rests on the observation that it is possible to express the dependency parse of an N-token (such as N words or letter combinations) sentence/string as a 2N-length sequence of transition operators (where those operators are described by Sh (“shift”), Re (“reduce”), Lt (“left arc”), and Rt (“right arc”)), e.g.:

“Oil lamp”=[S, R, L, S].

A transition-based dependency parser parses a sentence by finding the most likely sequence of transition operators, according to its trained statistical models. In a sense the parser is attempting to find that sequence of operators (where application of an operator enables a transition from a first node/token to a second node/token) that results in what it has “learned” to be the optimum or “best” parsing of the input string (based on evaluating a correctly parsed training set, and typically a comparison control set). Note that because of the ability to express the dependency parse of an N-token sentence/string as a 2N-length sequence of transition operators, the total number of possible operations can be determined based on the number of tokens in the input. This provides guidance on the estimated computational resources needed to parse a set of inputs and to correctly construct a treebank (and may be compared to the results provided by alternative approaches, such as an implementation of the inventive system and methods).

In a simplified form, a transition-based parser might implement a form of the following algorithm or process:

Parse (n-length sentence):

Transitions=[ ]

For i=1 to 2n
choose transition ε {Sh, Rt, Lt, Rt}
and append to set of transitions

Return transitions

The operators modify a stack-and-buffer until a single parse tree is formed on the stack. For instance, in the example given:

| Operator | Stack | Buffer |
|---|---|---|
| | TOP | oil, lamp |
| Shift | TOP, oil | lamp |
| Right | TOP | lamp <- oil |
| Left | TOP | <- lamp <- oil |
| Shift | TOP <- lamp <- oil | |

Note that one step in the algorithm or heuristic is to select or choose the “correct” transition operator from a set of allowable operators, as governed by one or more rules or constraints, and where the “correct” choice may depend on determination of an associated cost or value (such as the parsing being correct or incorrect). Thus, a separate concern is that of how to train or configure a parsing system that implements the algorithm to choose the correct transition operator. This aspect (that of training a classifier to identify the “best” or “correct” decision with regards to the appropriate transition operator) is typically addressed by some form of adaptive feedback system, an example of which will be described in greater detail herein.

FIG. 5 is a diagram illustrating certain functional or operational elements or processes that may be implemented as part of an embodiment of the invention. Each (or a combination) of the functions, operations, or processes performed by or under the control of the elements or modules shown in the figure may be performed by the execution of a set of instructions by a properly programmed processing element (such as a controller, state system, microcontroller, CPU, microprocessor, etc.).

As shown in the figure, a base parser 502 (that is, a parser or parsing engine previously trained on a different corpus of documents) is used to parse a set of sentences derived from a new corpus (contained in the “unparsed sentences” data storage element 504). An input, such as a control signal or instruction 505 (e.g., one generated by a human annotator or a control signal generated by an automated machine-learning or decision process) is provided to the “banker” 506 which operates to generate the parse trees and the resultant treebank by controlling, modifying, or instructing the operation of parser 502. The outputs of banker 506 are a set of parse trees (i.e., a treebank) that represent better or more correct parsing of the input strings 504, as denoted by “gold parses” 508 in the figure.

In a general sense, the banker 506 is receiving information from a user or model (in the form of an instruction 505) that causes the base parser 502 to more accurately parse inputs from a domain 504 that was not previously used to train the parser. The output (508) represents a more correctly parsed set of inputs (504) than would be obtained by the action of parser 502 in the absence of input 505. This is a form of re-training or adaptively modifying the behavior of parser 502 by providing it with incremental changes to its operation, rather than requiring a more extensive training set for the new domain (which, as noted, may not exist or be reliable enough for these purposes). One result of the inventive methods is thus to generate a set of correctly parsed input strings (a treebank) for the domain.

In one embodiment, the action of the annotator or control signal 505 may cause banker 506 to modify the operation of parser 502 by implementing one or more constraints, modifications, conditions, requirements, exclusions, or rules on the operation of the parser, such as the following examples:

ForbiddenArc(W,X): this means that in the final tree, do not permit an arc between words W and X; or

RequestedArc(W,X): this means that in the final tree, guarantee an arc between words W and X.

The ForbiddenArc and RequestedArc constraints operate to force the parser to exclude or include a particular connection between “units”, nodes, tokens, words, or elements in the output of the parser, which is a representation of the parsed input string or sentence. This may produce a different network/tree structure than would occur without introduction of the constraint. Thus, in some embodiments, the new condition or constraint functions to introduce knowledge from an “expert” (such as the annotator or a machine learning output) into the operation of the parser (via the interpretive or other operations performed by the banker), and thereby modify its behavior. As mentioned, the knowledge may be an input provided by a person (who is in effect using their expert knowledge/learning about grammar and sentence structure to indicate errors in the parser's operation on the input string) or by a machine learning, neural network, statistical analysis, or other automated decision process.

In some embodiments, a set of correctly parsed sentences (commonly termed “gold parses”) may be constructed using the inputs of an annotator. In other embodiments, a set of correctly (or in some instances, more correctly) parsed sentences may be constructed using the inputs of an automated decision process and/or annotator. Note that if an automated decision process is used, it will base its evaluation of whether a sentence parsing is correct (or more nearly correct) based on the value of a metric, goal function, rating, etc. Thus, the accuracy and predictive value of the decision process will depend to some extent upon how the metric or goal function is defined and constructed.

Given a set of correctly parsed sentences, this set may be used as examples or inputs to a machine learning or other automated process that uses the gold parses as examples for training purposes. This can be used to enable the parser to “learn” from the correct parsing(s) in order to intelligently adapt its operation, and become capable of efficiently constructing correct parses of sentences with little or no inputs from an annotator or automated evaluating process. A large enough set of such correctly parsed sentences may then be used as a treebank. This learning capability of the parser may be introduced through use of an adaptive feedback loop or “on-line learner” (e.g., perceptron or MIRA, two techniques that adapt the weights of a log-linear model in response to new training data).

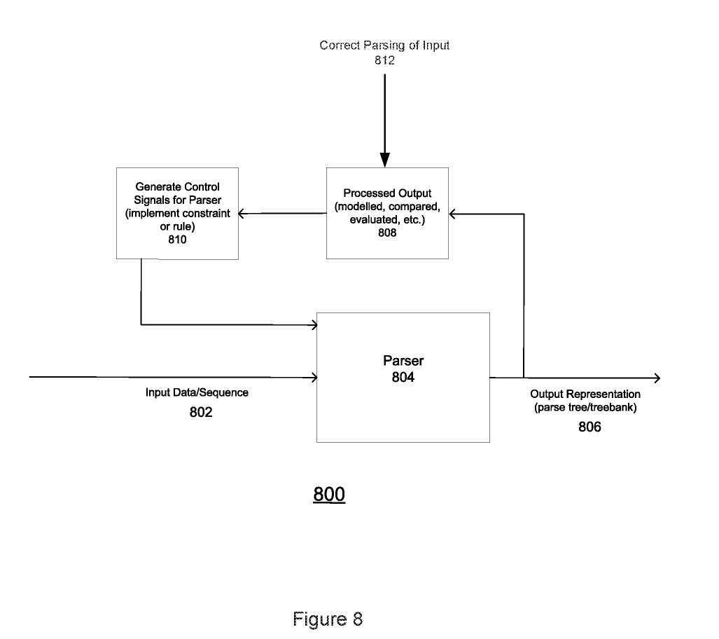

As mentioned, in some embodiments, an automated decision process may be used by itself or in conjunction with the inputs of an annotator to construct a set of correctly parsed sentences. In one embodiment, the automated decision process may be an adaptive feedback process that is used to replace or partially replace the inputs provided by the annotator. This can be an effective method of generating a larger set of correctly (or generally correctly) parsed sentences in situations where the reasoning of the annotator can be encapsulated in one or more explicit metrics, goal functions, rules, or other forms of evaluation. For example, FIG. 8 is a diagram illustrating certain elements of an adaptive feedback control loop 800 that may be used as part of a process, function, operation or method for assisting a parser to modify its behavior by “learning” from examples of correctly parsed inputs.

As shown in FIG. 8, in one embodiment or implementation, an input (such as a string, sentence, tokens, or data sequence) 802 is provided to parser 804. Parser 804 operates on input 802 to generate an output 806, which is a representation (such as a data structure, network or parse tree) of the parser's processing of the input. Note that because the parser was trained on a specific corpus that may or may not be sufficiently similar to the input sentence/corpus (in terms of grammar, element types, relationships between elements, etc.), the output may contain one or more errors such as incorrect links or relationships, incorrect labels, etc.

The output 806 may be sampled, interpreted, modelled, evaluated, etc. and compared in some manner to a correctly parsed version of the input (as suggested by element or process 808 and 812 in the figure). In some embodiments, this may be done by scoring or otherwise quantifying how the parsed input 806 compares to a known correctly parsed version 812 of that same input. This may be accomplished by generating a “score” or other metric that represents the result of comparing the parsed input to its known correct parsing, using a suitable scoring method, algorithm, heuristic, rule, condition, etc. that is implemented by element or process 808.

As one example, such a scoring method may be what is known as the “Unlabeled Attachment Score” (UAS). This method takes advantage of the property that every node of a rooted directed tree (except for the root) has exactly one parent. This permits re-expressing a parse tree in terms of a set of node-parent relationships. The UAS method constructs the node-parent relationships for both the parsed output and the known correct parsing, and then compares the two sets of relationships to generate a score (which may be the percentage of correct relationships that the parsed output contains).

In the situation in which the parse trees include labels (such as grammar parts), a scoring method known as “Labeled Attachment Score” (LAS) may be used. This method operates in a similar manner to UAS, but is able to take labels on arcs that connect nodes/tokens into consideration. In some sense, it evaluates the accuracy of the parser in identifying the correct label for a token or string element.

Given the comparison score or metric generated by element or process 808, adaptive feedback control loop 800 then generates a control signal or modified instruction for parser 804 using a suitable element or process 810 (e.g., a condition, constraint, rule, requirement, threshold, etc.). This control signal or modified instruction alters the operation of parser 804 (and in some embodiments, may implement certain of the same functions or processes as banker 508 in FIG. 5), and enables parser 804 to iteratively adapt its behavior so that it produces more accurate parsing(s) of the inputs. The control signal may be generated by use of a learning method or other suitable mechanism.

As mentioned, after parser 804 is able to generate sufficiently accurate parsing(s) of a set of inputs (based on inputs of an annotator and/or an automated decision process), a set of correctly labeled parse trees (which form the contents of a new treebank) may be used to train a classifier. The classifier (in this example, a 4-way classifier) operates to select the “best” transition operator (e.g., Shift, Reduce, Left Arc, Right Arc) given appropriate input data representing a characteristic of a node/label combination.

Below are additional examples of possible constraints, rules, conditions or instructions that may be applied to the operation of a base parser to improve its operation on example inputs from a new corpus. Certain of these possible constraints, rules, conditions or instructions may be relevant or most applicable for specific types of domains, grammars, sentences, sentence structures, sentence elements, characters, etc.:
ForbiddenArcLabel(W,X,L): in the final tree, do not allow an arc between words W and X to have label L [e.g., the parser may incorrectly create an arc between a preposition and a noun, even though the verb is not modified by that preposition (he saw the MAN WITH the telescope). This constraint allows the user to override this error.];
RequestedArcLabel(W,X,L): in the final tree, guarantee that any arc between words W and X is labeled with label L [e.g., the parser may incorrectly believe that the relationship of a noun to a verb is as a direct object instead of an indirect object (he GAVE HER a gift). This constraint allows the user to override this error.];
ForbiddenNodeLabel(W,L): in the final tree, do not allow the node representing word W to be labeled with label L (e.g., one might request that a word NOT be labeled with a particular part-of-speech tag (NOUN, VERB, etc.));
RequestedNodeLabel(W,L): in the final tree, guarantee that the node representing word W is labeled with label L (e.g., one might request that a word be labeled with a particular part-of-speech tag (NOUN, VERB, etc.)); or
MergeTokens(W,W+1): in the final tree, guarantee that words W and W+1 are represented with a single node, instead of two separate nodes (i.e., treat the two words as a single word—this is useful for multi-word expressions like “such as” or “in order to”).

Use of an embodiment of the invention can significantly expedite the improvement of a parser's operation on a new input type, category, or grammar that it was not previously or fully trained on. In this way, a parser that was trained on a standard training set (such as the Penn Treebank) may be modified or adapted to operate correctly and effectively on a new corpus of inputs (that may differ from those used to generate the Penn Treebank in terms of domain, category, type, grammar, input element characteristics, etc.) much more quickly than by starting with an untrained parser and trying to create a sufficiently large set of input data to properly and reliably train it.

In general, embodiments of the inventive system and methods relate to introducing constraints/controls into the operation of a parser that has previously been trained on a corpus of documents in order to more efficiently train the parser on a new and different corpus of documents. Note that a constraint or condition placed on the operation of the parser may depend in part or in whole, and directly or indirectly on a cost, value, parameter, a result of evaluating a function or process, a combination of parameters or variables and one or more logical operations (e.g., Boolean), etc.

In some embodiments, the value may be a cost or value as determined by a cost or value function that is used to determine the value of a connection between nodes in a network structure and/or the overall arrangement of the structure. The cost or value function may depend on one or more of context, implied meanings, domain type, etc. For example, when constructing a parse tree, the presence or absence of a connection between two words/nodes may depend on the value for the connection as determined by an applicable cost/value function for the network. This might be used to train a parser to avoid connections that are considered “weak” or “possible but considered improper” (e.g., slang, colloquial terms, etc.).

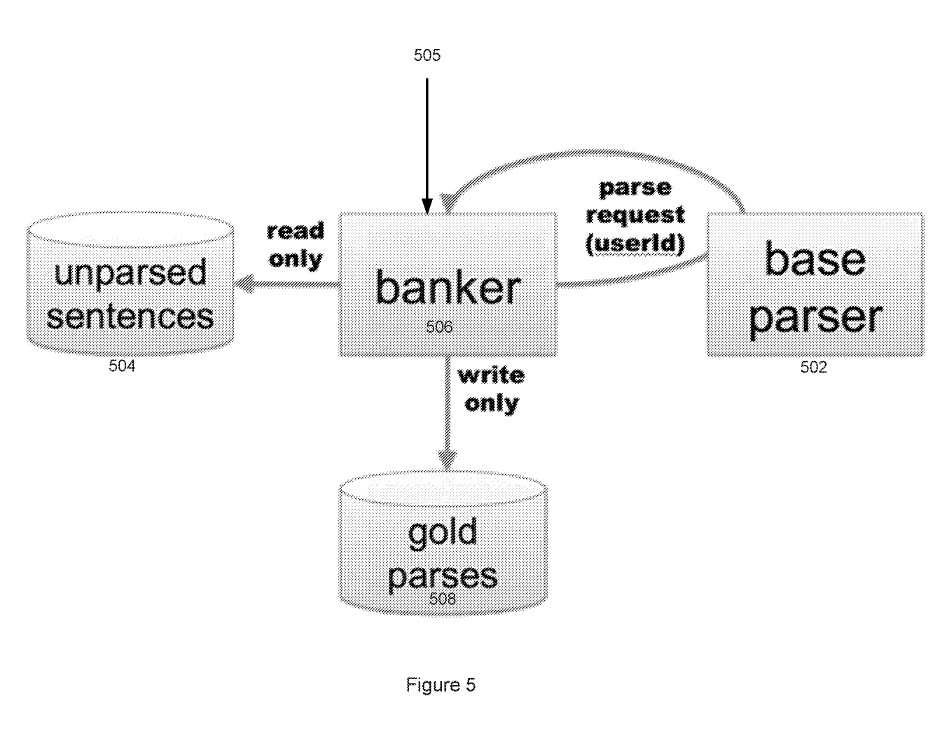

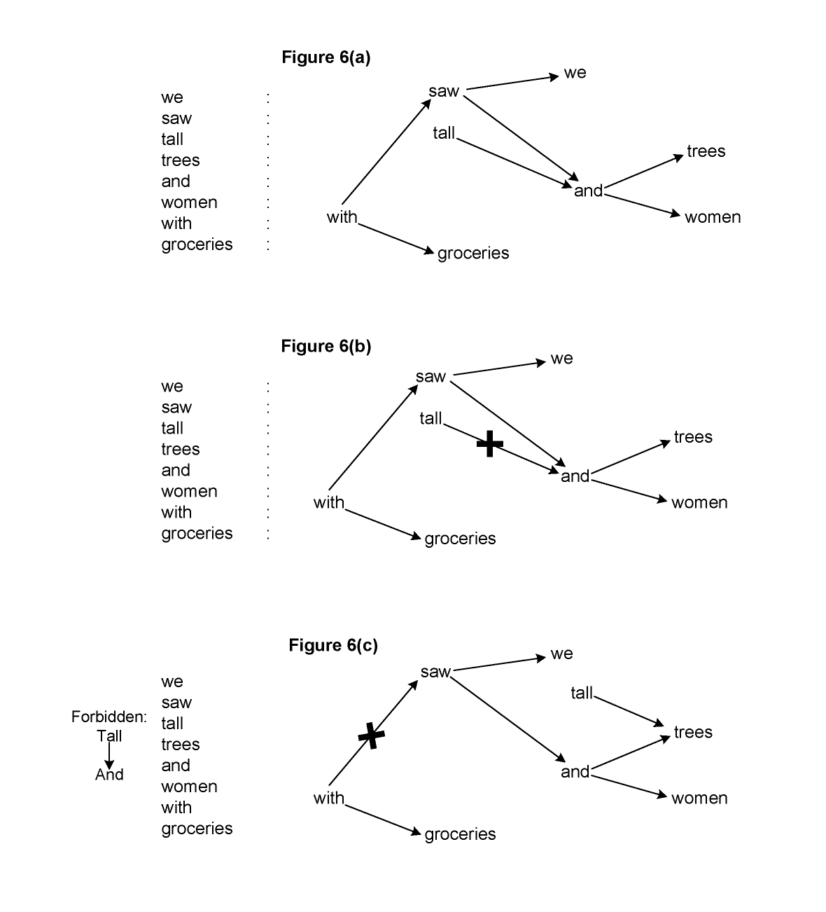

FIGS. 6(a) through 6(c) are diagrams illustrating how an input from an annotator or a decision process may be used to alter the operation of a previously trained parser when that parser is applied to an input from a different domain. As mentioned, one aspect of the invention is enabling the use of an automatic parser (previously trained on a domain-specific treebank, such as the Penn Treebank) to accelerate the process of treebanking inputs from a different domain.

As shown in FIG. 5, a human (or as mentioned, an automated decision or machine-learning process) is used to provide corrections or modifications to the automated parsing of a new input (such as sentence obtained from a different domain than the parser was previously trained upon). This generates a set of “gold parses” or corrected ones by the annotator. The annotation (either human or automated) process begins by presenting the best automated parse of an unparsed sentence (according to the base parser), as shown in FIG. 6(a).

Next, the annotator is asked to select/click on any incorrect link that may exist in the automatically generated parse, as shown in FIG. 6(b) by the “x”. Note that this selection may also be performed in part or in whole by an automated decision process, such as might result from a network model, application of one or more rule-based constraints, or use of a machine learning technique. This triggers the parser to reparse the sentence (without the selected link), and then the annotator is asked again to click on any incorrect link that may exist in the automatic parse, as shown in FIG. 6(c). Once the annotator is satisfied with the parse, he/she can select an “ok” button and the gold parse is saved to a database.

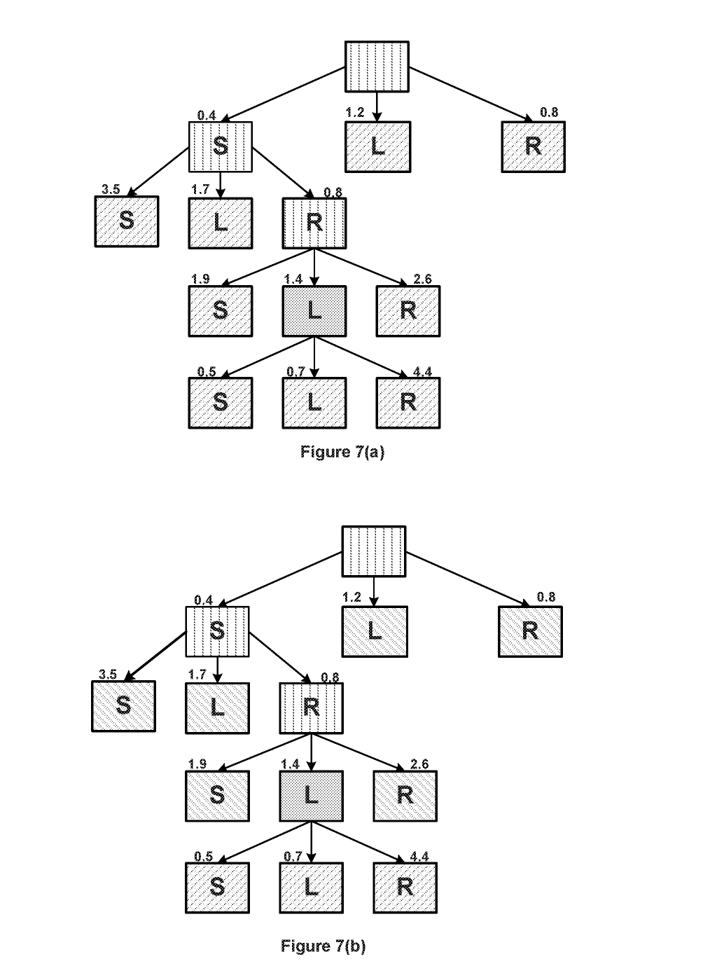

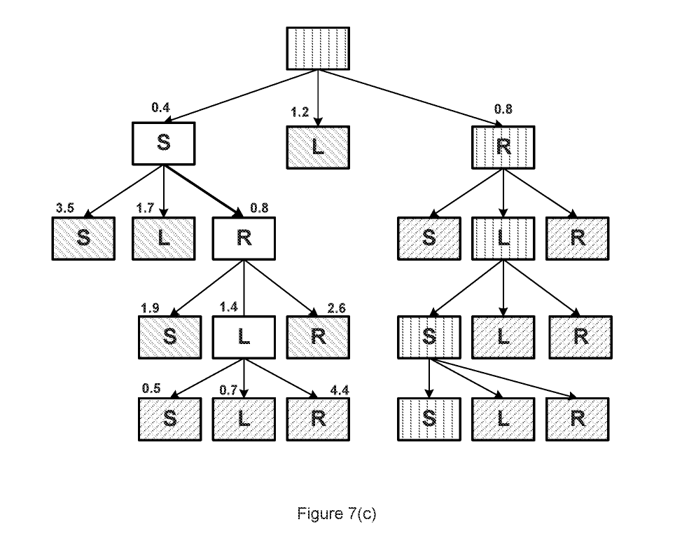

As will be described with further reference to FIGS. 7(a) through 7(c), the operations or functions illustrated in FIGS. 6(a) through 6(c) may be implemented by enabling base parser 502 to implement one or more constraints or conditions that are provided by banker 506 (in response to user or machine inputs). To account for these constraints or conditions during the parsing process, the parser 502 leverages the search tree over transition operators. An example of this is illustrated in FIGS. 7(a) through 7(c), which are diagrams illustrating how new constraints are used to train a parser on an input from a new domain by incorporating the constraints into the construction and traversing of a search tree.

As shown in FIG. 7(a), the search encounters a transition that is incompatible with the constraints (because the red link would create an arc between W and X, and there is a ForbiddenArc(W,X) constraint in effect). When this situation or constraint is encountered, the search reconsiders the set of previously discovered and discarded search nodes (highlighted in green), as shown in FIG. 7(b). Parser 502 then chooses the next best node (according to the delta between its cost and the greedy-best path cost, or another optimization criteria) and re-starts the search process from there. The process iterates until a goal node is found that satisfies all of the applied constraints. Note that in some cases this search can be implemented using a relatively simple stack-based agenda search.

In an embodiment in which machine learning or other automated process is used to evaluate the correctness of a proposed parsing to replace inputs from (or use in conjunction with) the actions of an annotator (e.g., create or generate the new rule, condition, or constraint to apply to the operation of the parser), this may be accomplished by a process such as the following:
Input new string;
Operate previously trained parser;
Calculate error function—derived from “negative” rules for grammar—connections that are either prohibited or sufficiently uncommon;
If value of error function exceeds predetermined threshold, then eliminate connection that was responsible;
Repeat error function calculation over all nodes and connections of network/tree;
Based on result, determine unlikely/incorrect/impermissible connections; and
Generate signal to parser controller to prevent such connections (such as by expressing as constraint or adjustment to value of cost function).
   Note that the above sequence is in some sense mimicking the thought process of a human annotator familiar with the corpus of documents from which the new set of inputs is obtained.

As mentioned, once a human annotator and/or automated learning process decides on how to correct an input, the banker module of FIG. 5 requires training in order to implement the rule, condition, constraint, modification, etc. As described, this may be done by using a 4-way classifier. A result is to convert the rule, condition, constraint, or other modification into a control signal or rule for a transition operator or state machine, thereby altering the algorithm previously described.

The trained classifier may then be used to modify the parsing algorithm discussed as follows:

Parse (n-length sentence):

Transitions=[ ]

For i=1 to 2n
ask classifier for best valid transition ε {Sh, Rt, Lt, Rt}
given feature vector
and append to set of transitions

Return transitions

(where a feature vector is a multidimensional numeric encoding of the current state of the parser).

Note that the inventive system and methods provide one or more of the following benefits or advantages, and may be used in one or more of the indicated contexts or use cases:
Interactive Treebanking—this embodiment of the invention provides a tool to assist/accelerate the process of creating gold standard dependency parses. In some implementations it does this via a back-end n-best parser with the ability to respond to user-specified constraints;
Polytree-based Parsing—this may be a dependency parser that relaxes the singly-rooted assumption of current parsers to provide a more natural, semantic-like representation. This has the potential to leverage semantic predicate-argument structures to improve parsing accuracy and can be used to provide a back end for the Interactive Treebanking invention described herein; or
Lightweight Parser Adaptation—a lightweight (i.e. low memory, training time) method to adapt parsers to the requirements of a new user, corpus, or genre of data.

Note further that for each unbanked sentence, there are two basic phases of operation of the inventive system and methods:
Interactive (iterative user based) banking: in this phase, given an unbanked sentence, the user provides constraints to the parser, which iteratively presents to the user the best parses it can find (according to a fixed or set model) that satisfy the constraint. This iteration continues until the user is satisfied with the overall parse; and
Online learning: in this phase, once a gold parse is settled upon for the unbanked sentence, the gold parse is used to adapt the parser model so that it will perform better on future sentences.

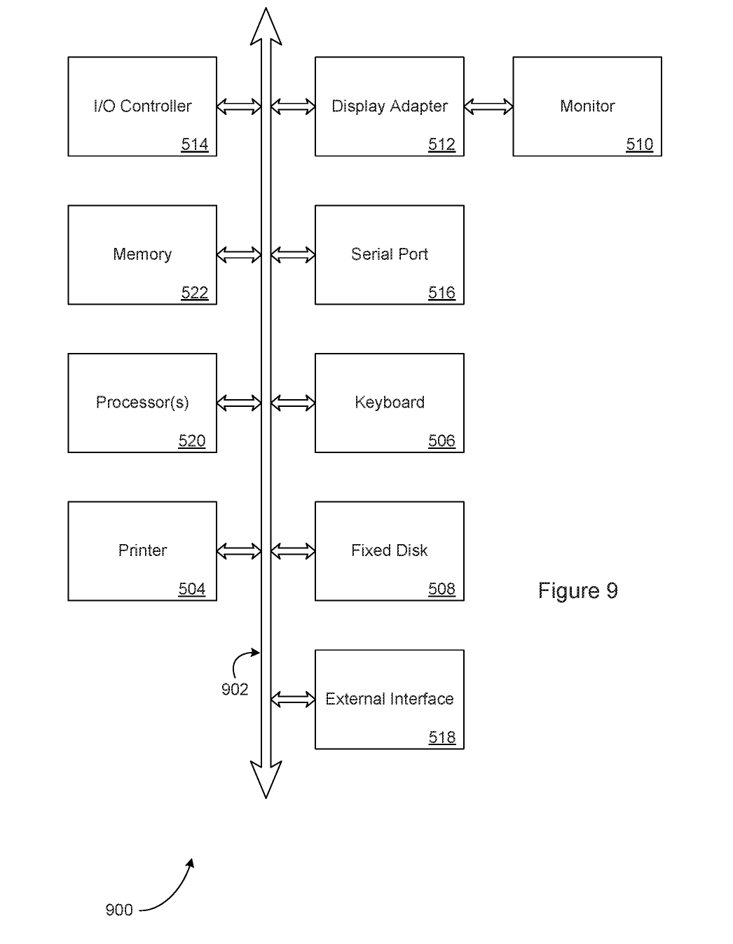

FIG. 9 is a diagram illustrating elements or components that may be present in a computer device or system configured to implement a method, process, function, or operation in accordance with an embodiment of the invention. As noted, in some embodiments, the inventive system and methods may be implemented in the form of an apparatus that includes a processing element and a set of executable instructions. The executable instructions may be part of a software application and arranged into a software architecture. In general, an embodiment of the invention may be implemented using a set of software instructions that are designed to be executed by a suitably programmed processing element (such as a CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module; for example, a function or process related to pre-processing input data (a sentence or string) for use by the parser, applying one or more rules or conditions based on the applicable grammar, identifying the role or purpose of certain input elements (such as words), identifying the relationship between certain input elements, generating a representation of the parser output, etc. Such function, method, process, or operation may also include those used to implement one or more aspects of the inventive system and methods, such as for:
Providing a user interface to enable an annotator to specify an error in the output of the parser, typically by indicating a constraint, requirement, or condition on a specific arc or connection between two elements in an output parse tree (and/or to receive an input from an automated learning or decision process);
Interpreting the constraint, requirement, or condition as a modification to the instructions that the parser uses to analyze the input;
Causing the parser to re-parse the input taking into account the indicated constraint, requirement, or condition; and
If desired, apply a specified cost or valuation function, or set of operations to evaluate a characteristic of the output, and based on that evaluation, generate a control signal to determine if a proposed parsing is acceptable (modify the operation of the parser) as part of an adaptive feedback control system.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As described, the system, apparatus, methods, processes, functions, and/or operations for implementing an embodiment of the invention may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 9 is a diagram illustrating elements or components that may be present in a computer device or system 900 configured to implement a method, process, function, or operation in accordance with an embodiment of the invention. The subsystems shown in FIG. 9 are interconnected via a system bus 902. Additional subsystems include a printer 904, a keyboard 906, a fixed disk 908, and a monitor 910, which is coupled to a display adapter 912. Peripherals and input/output (I/O) devices, which couple to an I/O controller 914, can be connected to the computer system by any number of means known in the art, such as a serial port 916. For example, the serial port 916 or an external interface 918 can be utilized to connect the computer device 900 to further devices and/or systems not shown in FIG. 9 including a wide area network such as the Internet, a mouse input device, and/or a scanner. The interconnection via the system bus 02 allows one or more processors 920 to communicate with each subsystem and to control the execution of instructions that may be stored in a system memory 922 and/or the fixed disk 908, as well as the exchange of information between subsystems. The system memory 922 and/or the fixed disk 908 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method for modifying the operation of a parser, comprising:
receiving data representing an input sentence;
generating a display of a structure representing the input sentence based on a specific parsing process;
receiving one or more inputs representing changes to the displayed structure;
generating a corrected structure representing the input sentence based on the specific parsing process as modified by the received inputs; and
training a parser to reliably learn a parsing process based on the specific parsing process as modified by the one or more received inputs.

2. The method of claim 1, wherein the display is a tree structure.

3. The method of claim 2, further comprising using the trained parser to generate a treebank.

4. The method of claim 1, wherein the one or more inputs are provided by an annotator and include or represent a rule, a constraint, a condition or an exclusion.

5. The method of claim 1, wherein the one or more inputs are provided by an automated decision process and include or represent a rule, a constraint, a condition or an exclusion.

6. The method of claim 1, wherein the parser is trained by using a classifier that operates to learn a sequence of parsing operations.

7. The method of claim 1, wherein the specific parsing process was developed based on a first corpus of sentences, and the input sentence is from a second corpus of sentences.

8. The method of claim 2, wherein the one or more inputs include or represent a rule, a constraint, a condition or an exclusion, and result in a requirement for a connection between two nodes of the structure or the prevention of a connection between two nodes of the structure.

9. An apparatus, comprising:
an electronic data processing element;
a set of instructions stored on a non-transient medium and executable by the electronic data processing element, which when executed cause the apparatus to
receive data representing an input sentence;
generate a display of a structure representing the input sentence based on a specific parsing process;
receive one or more inputs representing changes to the displayed structure;
generate a corrected structure representing the input sentence based on the specific parsing process as modified by the received inputs; and
train a parser to reliably learn a parsing process based on the specific parsing process as modified by the one or more received inputs.

10. The apparatus of claim 9, wherein the display is a tree structure.

11. The apparatus of claim 10, further comprising instructions causing the apparatus to use the trained parser to generate a treebank.

12. The apparatus of claim 9, wherein the one or more inputs are provided by an annotator and include or represent a rule, a constraint, a condition or an exclusion.

13. The apparatus of claim 9, wherein the one or more inputs are provided by an automated decision process and include or represent a rule, a constraint, a condition or an exclusion.

14. The method of claim 9, wherein the parser is trained by using a classifier that operates to learn a sequence of parsing operations.

15. The method of claim 9, wherein the specific parsing process was developed based on a first corpus of sentences, and the input sentence is from a second corpus of sentences.

16. The method of claim 11, wherein the one or more inputs include or represent a rule, a constraint, a condition or an exclusion, and result in a requirement for a connection between two nodes of the structure or the prevention of a connection between two nodes of the structure.

17. A system comprising:
a data storage element containing data representing one or more sentences or strings of characters;
an electronic data processing element;
a set of instructions stored on a non-transient medium and executable by the electronic data processing element, which when executed cause the system to
generate a visual display of a structure representing the result of parsing one of the sentences or strings of characters using a first parsing process;
receive one or more inputs representing changes to the displayed structure;
generate a visual display of a corrected structure, the corrected structure representing the result of parsing the sentence using the first parsing process as modified by the received inputs; and
train a parser execute a second parsing process, the second parsing process being based on the first parsing process as modified by the one or more received inputs.

18. The system of claim 17, wherein
the visual display is a tree structure;
the first parsing process was developed based on inputs from a first domain;
the one or more sentences or strings of characters are members of a second domain that would not be reliably parsed using the first parsing process; and
the one or more received inputs include or represent a rule, a constraint, a condition or an exclusion.

19. The system of claim 17, further comprising instructions causing the system to use the trained parser to generate a treebank using the data representing one or more sentences or strings of characters.
